(19) United States
(12) Patent Application Publication
(10) Pub. No.: US 2025/0138276 A1
(43) Pub. Date: May 1, 2025

(54) LENS DEVICE AND IMAGING APPARATUS

(71) Applicant: CANON KABUSHIKI KAISHA, Tokyo (JP)

(72) Inventor: YASUSHI MURAKAMI, Tochigi (JP)

(21) Appl. No.: 18/931,817

(22) Filed: Oct. 30, 2024

(30) Foreign Application Priority Data
Oct. 31, 2023 (JP) 2023-187259

(51) Int. Cl. G02B 7/09

(52) U.S. Cl. CPC G02B 7/09

(57) ABSTRACT

A lens device includes a first barrel member, and a second barrel member configured to move relative to the first barrel member and at least partially overlap the first barrel member in a radial direction, and an elastic member fixed to one of the first barrel member and the second barrel member, wherein at least a part of the elastic member is arranged in a gap between the first barrel member and the second barrel member, and wherein one of the first barrel member and the second barrel member to which the elastic member is fixed is provided with a protruding portion protruding toward the other of the first barrel member and the second barrel member at a part in contact with the elastic member.

### BACKGROUND

### Technical Field

The present disclosure relates to a lens device and an imaging apparatus.

### Description of the Related Art

Conventionally, a lens device mounted on an imaging apparatus, such as a single-lens reflex camera, is provided with a pair of barrel members that rotate or move linearly relative to each other. A gap is provided between the pair of barrel members that move relative to each other. There is known a lens device in which an elastic member is arranged to prevent intrusion of water droplets or dust into the lens device through the gap.

Japanese Patent Application Laid-Open No. H11-119075 discusses a lens device including an elastically deformable seal member that is made of silicone rubber or the like and is provided with a fin portion to fill the gap between a pair of barrel members.

Japanese Patent Application Laid-Open No. 2005-17392 discusses a lens device including a waterproof member that is made of rubber and is provided with a plurality of protruding portions in an annular groove.

### SUMMARY

According to an aspect of the present disclosure, a lens device includes a first barrel member, and a second barrel member configured to move relative to the first barrel member and at least partially overlap the first barrel member in a radial direction, and an elastic member fixed to one of the first barrel member and the second barrel member, wherein at least a part of the elastic member is arranged in a gap between the first barrel member and the second barrel member, and wherein one of the first barrel member and the second barrel member to which the elastic member is fixed is provided with a protruding portion protruding toward the other of the first barrel member and the second barrel member at a part in contact with the elastic member.

Further features of the present disclosure will become apparent from the following description of exemplary embodiments with reference to the attached drawings.

### BRIEF DESCRIPTION OF THE DRAWINGS

FIG. 1 is a cross-sectional view of a lens device in a wide-angle state.

FIG. 2 is a cross-sectional view of the lens device in a telephoto state.

FIG. 3 is a perspective view of a first barrel member.

FIG. 4 is a perspective view of the first barrel member.

FIG. 5 is a perspective view of a guide barrel.

FIG. 6 is a perspective view of a second barrel member.

FIG. 7 is a development view of an elastic member as viewed from an adhesive surface.

FIG. 8 is an enlarged view of the lens device including the elastic member.

FIG. 9 is an enlarged view of the lens device including the elastic member.

FIG. 10 is a cross-sectional view of the second barrel member and the elastic member.

FIG. 11 is a cross-sectional view of the second barrel member and the elastic member.

FIG. 12 is a perspective view of the second barrel member and the elastic member.

FIG. 13 is an enlarged view of a lens device including an elastic member according to a second exemplary embodiment.

FIG. 14 is an enlarged view of a lens device including an elastic member according to a third exemplary embodiment.

### DESCRIPTION OF THE EMBODIMENTS

Exemplary embodiments will be described below in detail with reference to the drawings. In the drawings, the same reference numerals are given to the same components, and duplicated description thereof will be omitted.

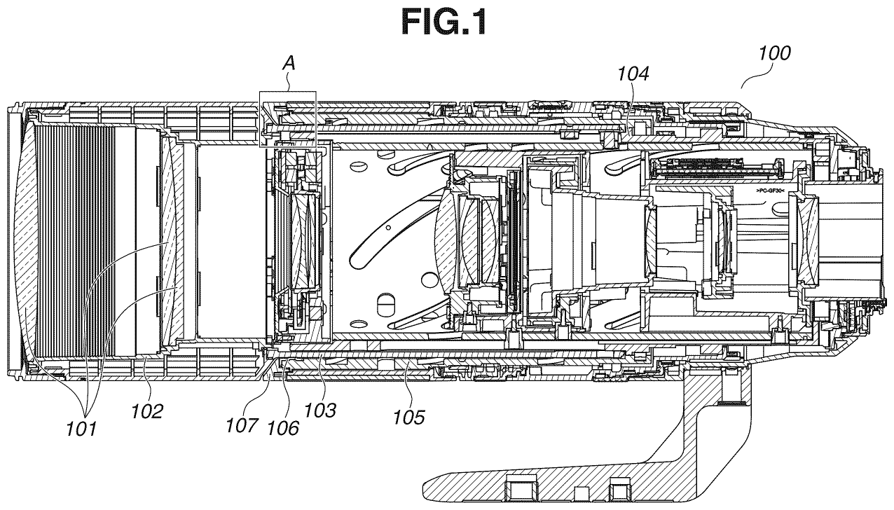

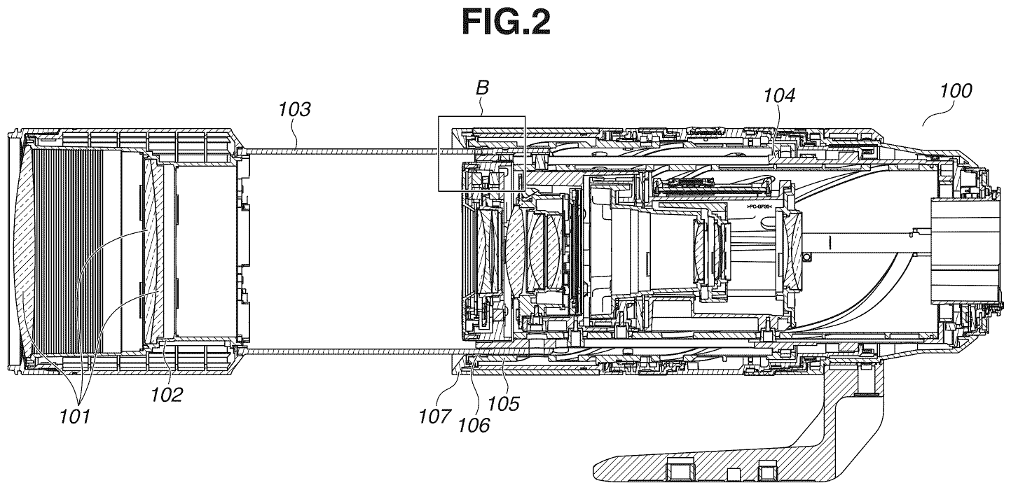

A configuration of a lens device 100 including an elastic member according to a first exemplary embodiment will be described with reference to FIGS. 1 and 2. FIG. 1 is a cross-sectional view of the lens device 100 (lens barrel) including the elastic member in a wide-angle state (wide-angle side) according to the first exemplary embodiment. FIG. 2 is a cross-sectional view of the lens device 100 including the elastic member in a telephoto state (telephoto side) according to the first exemplary embodiment. The lens device 100 is attachable to and detachable from a camera body including an imaging element, such as a charge-coupled device (CCD) sensor and a complementary metal-oxide semiconductor (CMOS) sensor (not illustrated). The camera body is configured to be capable of capturing an image formed through the lens device 100. The lens device 100 is provided with a mount, which is detachably attached to a mount on the camera body. The imaging apparatus including the lens device 100 according to the first exemplary embodiment is not limited to an imaging system, and includes a camera with interchangeable lenses, a camera with an integrated lens, and the like. The camera includes imaging apparatuses such as a digital still camera and a video camera.

The lens device 100 includes a lens as an optical element. The lens device 100 includes a first group lens 101 arranged on a subject side (the left side of the drawing) and held in a first group lens barrel 102, a first barrel member 103, a guide barrel 104, a second barrel member 105, an elastic member 106, and a front cover 107.

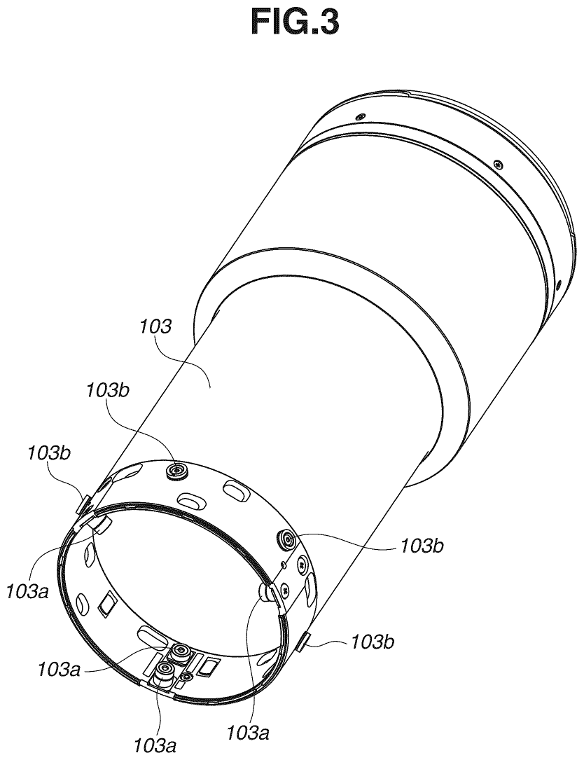

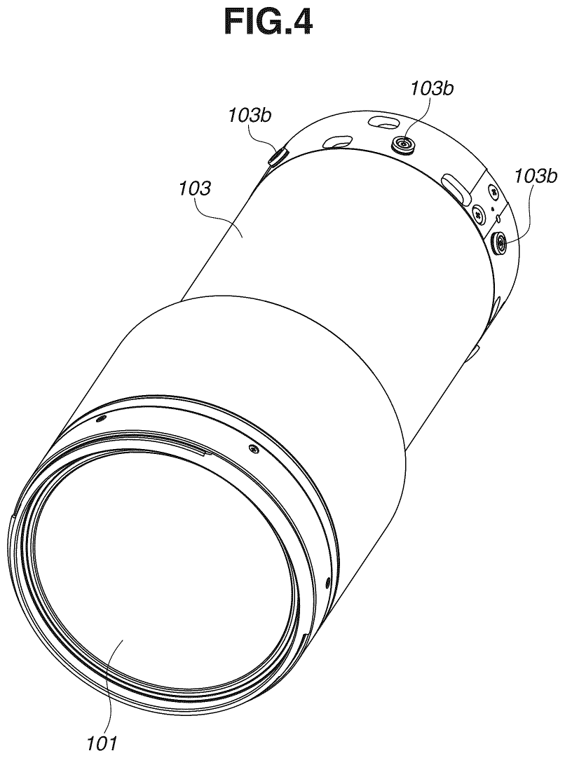

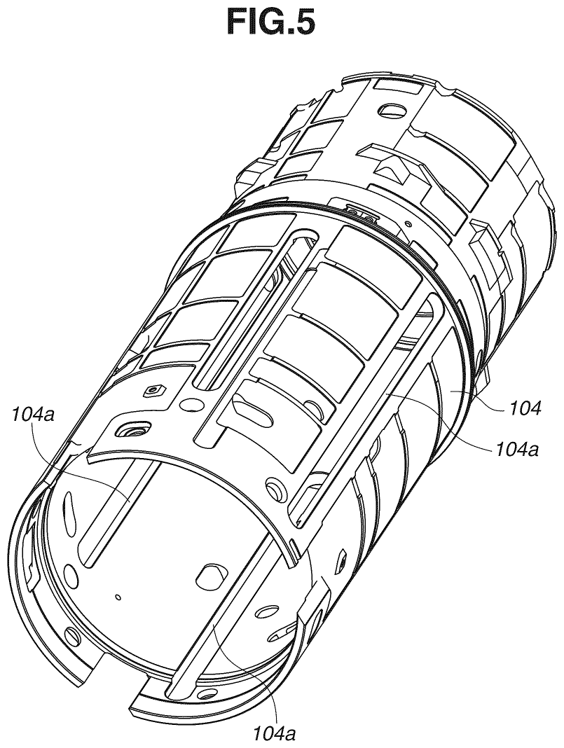

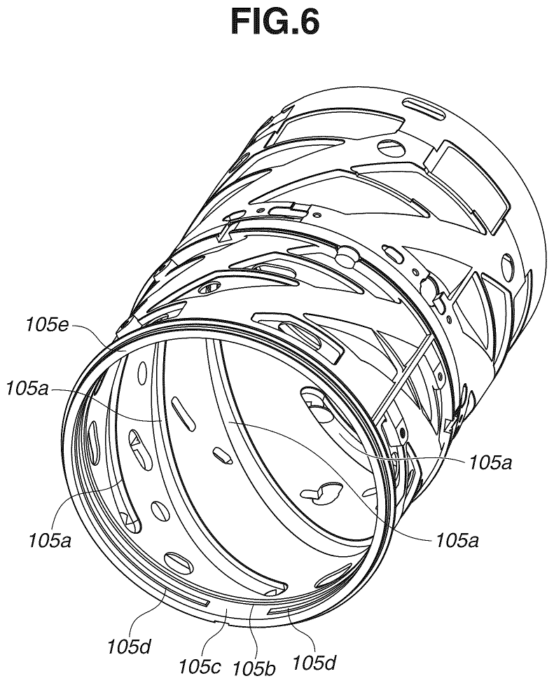

The first group lens barrel 102 is fixed to the first barrel member 103. As illustrated in FIGS. 3 and 4, the first barrel member 103 is provided with a plurality of first cam followers 103a and a plurality of second cam followers 103b. As illustrated in FIG. 5, the guide barrel 104 is provided with a plurality of guide grooves 104a that engages with the first cam followers 103a. As illustrated in FIG. 6, the second barrel member 105 is provided with a plurality of cam grooves 105a that engages with the second cam followers 103b.

The second barrel member 105 is held so as to be rotatable relative to the guide barrel 104. The first barrel member 103 and the second barrel member 105 are arranged so as to overlap at least partially in a radial direction.

Next, a zoom mechanism of the lens device 100 will be described. Since the first cam followers 103a and the second cam followers 103b engage with the cam grooves 105a of the second barrel member 105 and the guide grooves 104a of the guide barrel 104, when the second barrel member 105 rotates, these cam followers slide, and the first barrel member 103 moves in an optical-axis direction. Such a zoom operation causes the first group lens 101, the first group lens barrel 102, and the first barrel member 103 to move toward the subject side (object side) along with a state change from the wide-angle state (FIG. 1) to the telephoto state (FIG. 2).

### (Drip-Proof Structure)

Next, the principle of a drip-proof structure provided in the lens device 100 and an assembly process thereof according to the exemplary embodiment will be described.

As described above, when the second barrel member 105 rotates, the first group lens 101, the first group lens barrel 102, and the first barrel member 103 move forward and backward in the optical axis direction. In the telephoto state as illustrated in FIG. 2, a cylindrical part of the first barrel member 103 is exposed to an outer diameter side of the lens device 100. On the other hand, in the wide-angle state as illustrated in FIG. 1, the cylindrical part of the first barrel member 103 is stored inside the second barrel member 105. In other words, if the second barrel member 105 is operated in an environment where water droplets adhere to the first barrel member 103, the water droplets may intrude into the lens device 100. The intrusion of the water droplets into the lens device 100 is caused not only by a surface of the first barrel member 103 with the water droplets being drawn in, but also by a change in an internal volume of the lens device 100 due to the zoom operation. This is because air flows in through a gap in the lens device 100 in a direction in which the volume of the lens device 100 increases. For this reason, in the lens device 100, the elastic member 106 is disposed to prevent intrusion of water through the gap between the first barrel member 103 and the second barrel member 105.

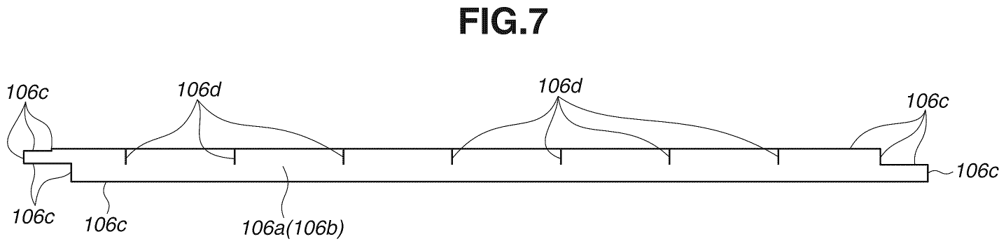

FIG. 7 illustrates a development view of the elastic member 106 before being attached to the lens device 100. The elastic member 106 is a sheet member of a uniform thickness that is made of elastic nonwoven fabric or woolen fabric (for example, Ecsaine by Toray Industries, Inc. can be used), and has water absorption properties, for example. The sheet member as the elastic member 106 may have a portion with a different thickness from the other portion.

One surface of the elastic member 106 is an adhesive surface 106a made of double-sided adhesive tape. A surface of the elastic member 106 opposite to the adhesive surface 106a (the back side of the adhesive surface 106a) illustrated in FIG. 7 is a water repellent coated surface 106b that is coated with a water repellent. The water repellent enables the elastic member 106 to easily repel water, and waterproof performance of the elastic member 106 improves. The elastic member 106 also desirably has a property of absorbing water that has not been repelled by the water repellent coated surface 106b and reached the inside of the elastic member 106. On the other hand, cross section parts 106c connecting the adhesive surface 106a and the water repellent coated surface 106b are surfaces along which the sheet member is cut to form the elastic member 106 by punching the sheet member. Since the cross section parts 106c are not coated with a water repellent, the cross section parts 106c are less effective in water repellency and are prone to absorb water. The elastic member 106 also has cuts 106d therein, so that the elastic member 106 can be bent and attached to an opening of the second barrel member 105.

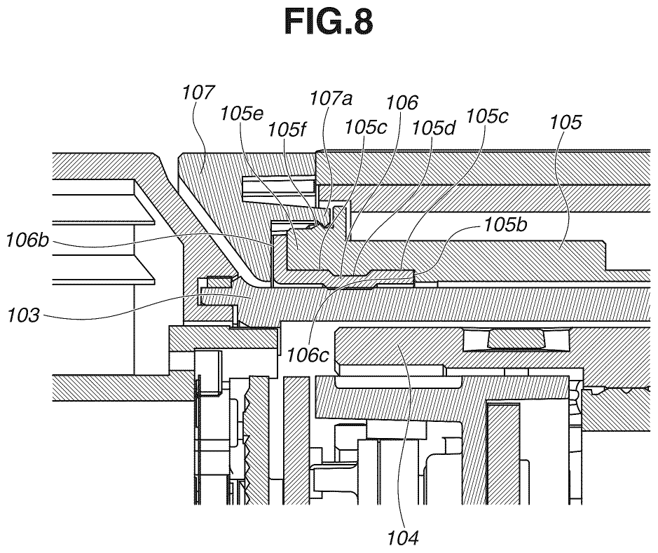

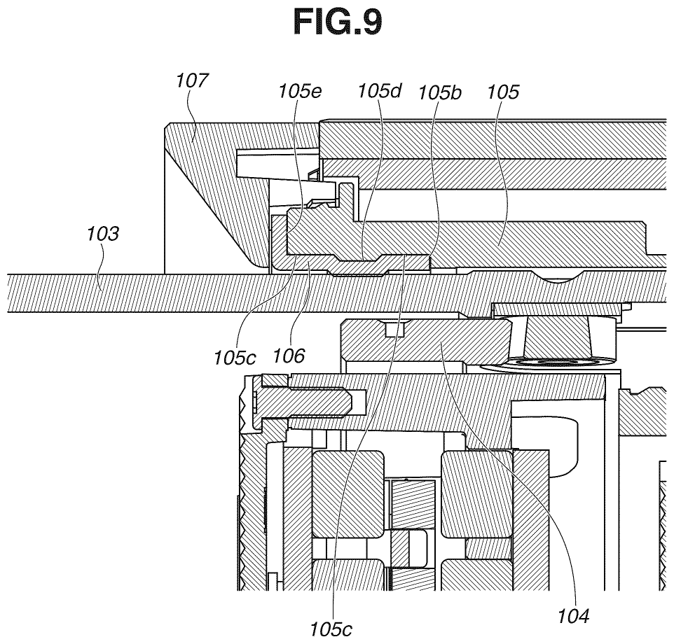

A state in which the elastic member 106 is attached to an inner diameter surface of the second barrel member 105 will be described with reference to FIGS. 8 and 9. FIG. 8 is an enlarged view of a part A of the lens device 100 in the wide-angle state illustrated in FIG. 1. FIG. 9 is an enlarged view of a part B of the lens device 100 in the telephoto state illustrated in FIG. 2.

The elastic member 106 is attached to an inner diameter portion of the second barrel member 105. The second barrel member 105 includes a restriction part 105b that restricts a movement of the elastic member 106 in the optical axis direction. The elastic member 106 is attached thereto with the cross section parts 106c of the elastic member 106 illustrated in FIG. 7 being attached along the restriction part 105b. The elastic member 106 is attached to an inner diameter part 105c and a protruding portion 105d that protrudes from the inner diameter part 105c. Accordingly, a partial area of the elastic member 106 attached to the inner diameter portion of the second barrel member 105 is deformed into a shape that protrudes toward the first barrel member 103.

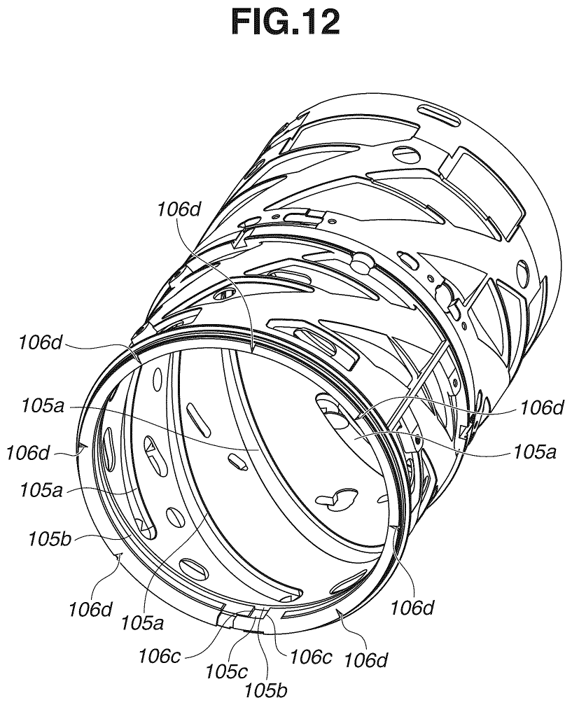

As illustrated in FIG. 6, the protruding portion 105d may be intermittent in a circumferential direction. As illustrated in FIG. 12, when the elastic member 106 is circumferentially attached, the cross section parts 106c, which are end faces in the circumferential direction, are arranged in an area where the protruding portion 105d is not formed. Accordingly, the cross section parts 106c, which are circumferential joints, can be configured not to run over the protruding portion 105d. Thus, the cross section parts 106c equivalent to the circumferential joints do not protrude in the radial direction, so that a portion that abuts on the first barrel member 103 is limited to the protruding portion 105d. As described above, when the cross section parts 106c are configured not to abut on the protruding portion 105d in the optical axis direction and in the circumferential direction, it is possible to prevent an increase in zoom torque caused by the cross section parts 106c becoming tangled in a zoom operation. In addition, an area of the protruding portion 105d can be set as a minimum area where drip-proof performance is ensured.

Accordingly, it is possible to reduce the area of the elastic member 106 that abuts on the first barrel member 103 in the optical axis direction. It is also possible to minimize variation in a force of the elastic member 106 that is applied to the first barrel member 103 due to changes in a charge amount that is caused by the difference in the thickness of the elastic member 106. As described above, when a part of an area of the second barrel member 105 that comes into contact with the elastic member 106 has a protruding shape protruding in the radial direction, it is possible to suppress an increase of the torque and reduce variation in torque without deteriorating the waterproof performance.

The sheet-like elastic member 106 is attached to the second barrel member 105 in the circumferential direction. Thus, reducing a component error of the protruding portion 105d in the radial direction relative to the inner diameter part 105c suppresses variation in the charge amount of the elastic member 106 to the first barrel member 103, and achieves a stable biasing force. Since variation in the force of the elastic member 106 applied to the first barrel member 103 can be suppressed, the variation in the torque that rotates the second barrel member 105 can also be suppressed.

In the present exemplary embodiment, the shape of the protruding portion 105d is trapezoidal as illustrated in FIG. 8 as viewed in a cross section including the optical axis. However, the shape of the protruding portion 105d is not limited to a trapezoidal shape, and may be arc-shaped. Various modifications and changes are possible within the scope of the gist of the present disclosure.

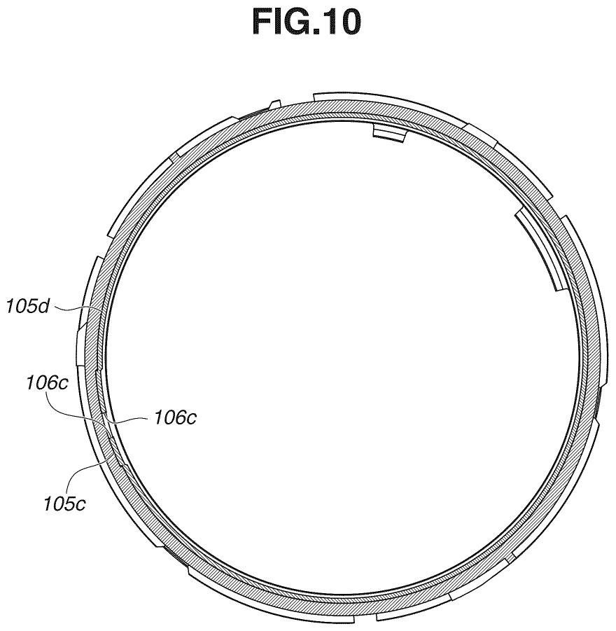

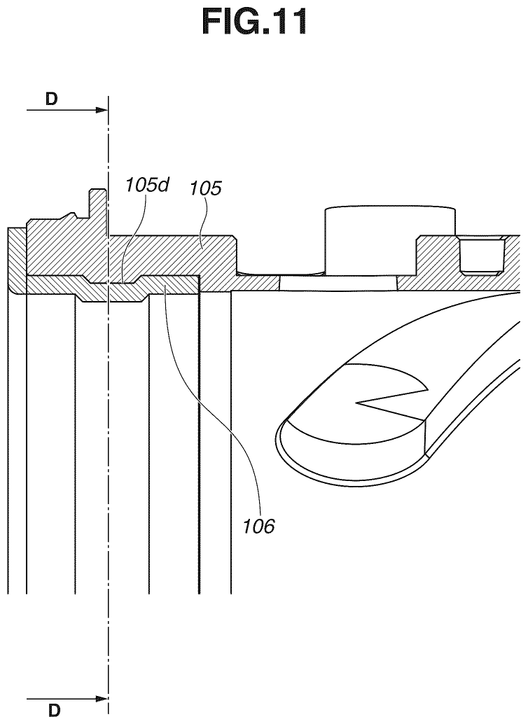

As illustrated in FIG. 10, at least the protruding portion 105d is disposed directly below the lens device 100 (in the direction of gravity of the lens device 100 attached to the camera body). FIG. 10 is a view of a surface (cross section D-D) perpendicular to the optical axis including the protruding portion 105d along the optical axis as illustrated in FIG. 11. This allows the elastic member 106 to apply a force to the first barrel member 103 against the direction of gravity. It is also possible to suppress the first barrel member 103 from falling in the direction of gravity. Since a tip portion of the first barrel member 103 is heavy in weight, it is possible to prevent an increase in zoom torque caused by application of moment.

FIG. 12 is a perspective view illustrating a state in which the elastic member 106 is attached to the second barrel member 105. As illustrated in FIG. 12, a tip portion of the elastic member 106 on the subject side is bent and attached along a tip shape of the opening of the second barrel member 105. As illustrated in FIGS. 8 and 9, the elastic member 106 is bent into an L shape along the inner diameter part 105c and a tip shape 105e. As illustrated in FIG. 12, the elastic member 106 has the cuts 106d formed in a plurality of places. These cuts 106d can suppress tension of the elastic member 106 when the elastic member 106 is bent into an L shape, and therefore peeling of the elastic member 106 can be prevented.

As illustrated in FIG. 8, the front cover 107 is attached to the second barrel member 105 to which the elastic member 106 is attached. In order to fix the front cover 107, the second barrel member 105 includes a fixing part 105f. The fixing part 105f has a protruding shape that protrudes toward the outer diameter, and is formed on the entire circumference of the tip portion of the second barrel member 105 on the subject side. On the other hand, as illustrated in FIG. 8, the front cover 107 includes a claw part 107a. The claw part 107a has a protruding shape (claw part) that protrudes toward a central direction, and is arranged at a plurality of places on the front cover 107 (for example, in three different phases in the circumferential direction). When the claw part 107a runs over the fixing part 105f, a force acts to attract the front cover 107 and the second barrel member 105 to each other, so that the elastic member 106 is sandwiched and fixed between the front cover 107 and the second barrel member 105.

While the lens device 100 is operated from the telephoto state (FIG. 9) to the wide-angle state (FIG. 8), if water droplets adhere to the outer peripheral surface of the first barrel member 103 and are drawn toward an image pickup surface side, the water repellent coated surface 106b of the elastic member 106 comes into contact with an intrusion path thereof. In this way, since surfaces other than the water repellent coated surface 106b do not directly come into contact with the water droplets, the elastic member 106 is unlikely to absorb the water droplets, thereby the drip-proof performance is improved.

A configuration of the related art in which the elastic member is provided with a fin portion or a plurality of protruding portions is unstable in terms of the shape in the assembled state, and it is difficult to maintain a contact relation with a mating member in a predetermined state. In addition, due to complexity of the shape, it is difficult to stably achieve component accuracy. Depending on variation, the torque of an operating member may fluctuate greatly. In contrast to this configuration, since the sheet-like elastic member 106 is wound around the second barrel member 105 in the configuration according to the present exemplary embodiment, the charge amount of the elastic member 106 to the first barrel member 103 is determined by a height of the protruding portion 105d relative to the inner diameter part 105c and a thickness of the elastic member 106. Thus, by reducing the component error, a stable biasing force is obtained. By suppressing the variation in the force of the elastic member 106 applied to the first barrel member 103, the variation in the torque that rotates the second barrel member 105 is suppressed.

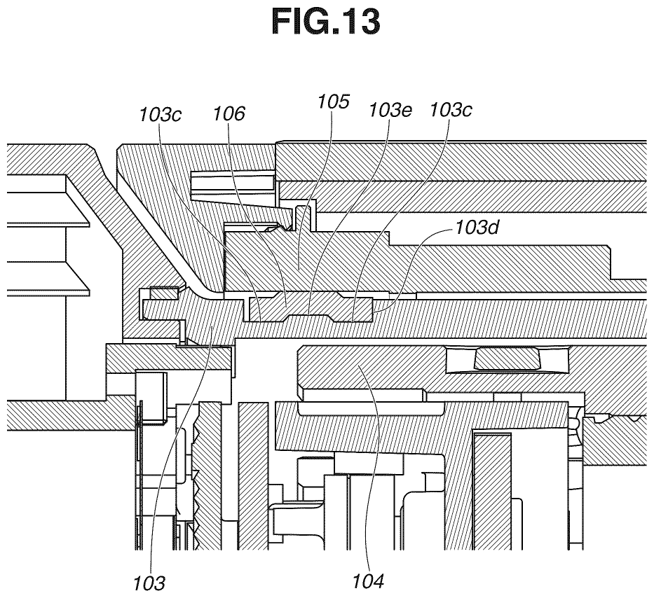

A configuration of a lens device according to a second exemplary embodiment will be described with reference to FIG. 13. Description of matters in common with the first exemplary embodiment will be omitted, and differences from the first exemplary embodiment will be described. FIG. 13 is a partially enlarged cross-sectional view of a lens device including a first barrel member 103 provided with an elastic member 106 and a second barrel member 105.

As illustrated in FIG. 13, the first barrel member 103 according to the second exemplary embodiment is immovably fixed to a guide barrel 104 with a screw (not illustrated). The second barrel member 105 is rotatably held with respect to the guide barrel 104. Therefore, the first barrel member 103 and the second barrel member 105 constitute a pair of barrel members that rotate relative to each other.

The elastic member 106 according to the second exemplary embodiment is attached to an outer diameter part of the first barrel member 103. The first barrel member 103 includes a restriction part 103d that restricts a movement of the elastic member 106 in the optical axis direction. At the time of attachment, a cross section part 106c of the elastic member 106 is attached along the restriction part 103d. The elastic member 106 is attached to an outer diameter part 103c and a protruding portion 103e that protrudes from the outer diameter part 103c.

The elastic member 106 may be arranged on the second barrel member 105, which is arranged on the outer peripheral side of the first barrel member 103, as well as on the outer peripheral side of the first barrel member 103. Furthermore, the first barrel member 103 and the second barrel member 105 may relatively move in the optical axis direction as well as relatively move in a rotation direction (circumferential direction) around the optical axis. Even in such a case, a protruding portion can be provided on the first barrel member 103 to which the elastic member 106 is fixed, such that a part of a gap between the first barrel member 103 to which the elastic member 106 is arranged and the second barrel member 105 becomes narrow in the radial direction.

Accordingly, it is possible to reduce the area of the elastic member 106 that abuts on the second barrel member 105 in the optical axis direction. As described above, when a part of an area of the first barrel member 103 that contacts the elastic member 106 has a protruding shape protruding in the radial direction, it is possible to suppress an increase of the torque and reduce variation in torque without deteriorating the waterproof performance.

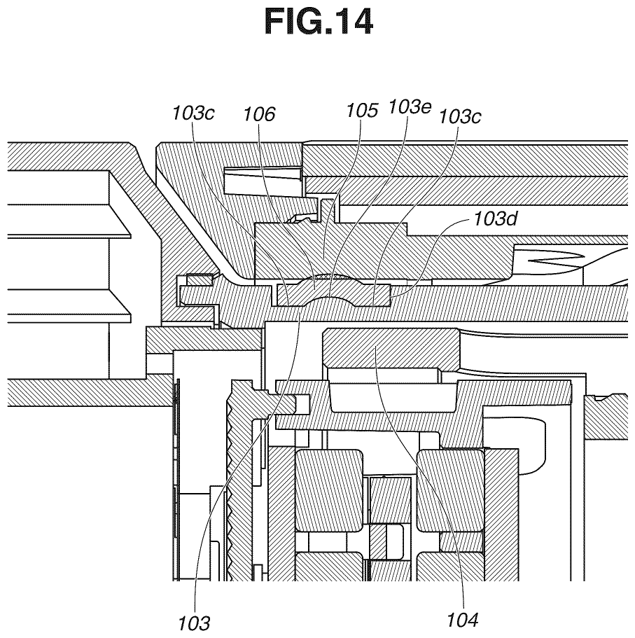

A configuration of a lens device according to a third exemplary embodiment will be described with reference to FIG. 14. Description of matters in common with the first and second exemplary embodiments will be omitted, and differences will be described. FIG. 14 is a partially enlarged cross-sectional view of a lens device including a first barrel member 103 provided with an elastic member 106 and a second barrel member 105.

As illustrated in FIG. 14, the lens device according to the third exemplary embodiment is different from the lens device according to the second exemplary embodiment in the shape of a protruding portion 103e. As illustrated in FIG. 13, the shape of the protruding portion 103e according to the second exemplary embodiment is trapezoidal (rectangular) as viewed in a cross section including the optical axis. On the other hand, as illustrated in FIG. 14, the shape of the protruding portion 103e according to the third exemplary embodiment is an arc shape as viewed in a cross section including the optical axis.

As described above, the shape of the protruding portion 103e, which is provided such that a part of the gap between the first barrel member 103 provided with the elastic member 106 and the second barrel member 105 is narrowed in the radial direction, is not limited to a specific shape as long as the shape protrudes from an outer diameter part 103c. Even if the shape of the protruding portion 103e of the first barrel member 103 is an arc shape, it is possible to reduce the area of the elastic member 106 that abuts on the second barrel member 105 in the optical axis direction. As described above, when a part of an area of the first barrel member 103 that comes into contact with the elastic member 106 has a protruding shape protruding in the radial direction, it is possible to suppress an increase of the torque and reduce variation in torque without deteriorating the waterproof performance.

In each of the above-described exemplary embodiments, the elastic member 106 is attached so as to cover the protruding portion formed on one of the first barrel member 103 and the second barrel member 105. However, the elastic member 106 does not have to cover the entire protruding portion. For example, the protruding portion may be positioned on an end surface of the elastic member 106 in the optical axis direction. When the elastic member 106 is attached so as to cover at least a part of the protruding portion, the elastic member 106 can be arranged in the gap between the first barrel member 103 and the second barrel member 105.

While the exemplary embodiments have been described, the present disclosure is not limited to these exemplary embodiments, and various modifications and changes are possible within the scope of the gist of the present disclosure. The present disclosure can be applied to a lens device that can be attached to a camera body of a single-lens reflex digital camera or a mirrorless camera.

The scope of the following claims is to be accorded the broadest interpretation so as to encompass all such modifications and equivalent structures and functions.

This application claims the benefit of Japanese Patent Application No. 2023-187259, filed Oct. 31, 2023, which is hereby incorporated by reference herein in its entirety.

What is claimed is:

1. A lens device comprising:
a first barrel member; and
a second barrel member configured to move relative to the first barrel member and at least partially overlap the first barrel member in a radial direction; and
an elastic member fixed to one of the first barrel member and the second barrel member,
wherein at least a part of the elastic member is arranged in a gap between the first barrel member and the second barrel member, and
wherein one of the first barrel member and the second barrel member to which the elastic member is fixed is provided with a protruding portion protruding toward the other of the first barrel member and the second barrel member at a part in contact with the elastic member.

2. The lens device according to claim 1, wherein, when the elastic member is fixed so as to cover the protruding portion, the elastic member protrudes toward the other of the first barrel member and the second barrel member.

3. The lens device according to claim 2, wherein the protruding elastic member is in contact with the other of the first barrel member and the second barrel member.

4. The lens device according to claim 1, wherein one of the first barrel member and the second barrel member includes a restriction part restricting a movement of the elastic member in a direction along an optical axis of the lens device.

5. The lens device according to claim 4, wherein the elastic member is arranged such that a cross section part opposite to, in the direction along the optical axis, a cross section part abutting on the restriction part is along an opening of one of the first barrel member and the second barrel member in a circumferential direction.

6. The lens device according to claim 5, wherein the elastic member is arranged so as to cover at least a part of an end surface of the opening on an object side.

7. The lens device according to claim 1, wherein the elastic member is a sheet-like member and is fixed to one of the first barrel member and the second barrel member in a circumferential direction.

8. The lens device according to claim 1, wherein a cross section part of the elastic member in a circumferential direction is fixed in an area where the protruding portion is not provided.

9. The lens device according to claim 1, wherein the elastic member is made of a nonwoven fabric.

10. The lens device according to claim 1, wherein the first barrel member is arranged on an inner diameter side of the second barrel member, and the protruding portion is arranged on the inner diameter side of the second barrel member.

11. The lens device according to claim 1, wherein the first barrel member is arranged on an inner diameter side of the second barrel member, and the protruding portion is arranged on an outer diameter side of the first barrel member.

12. The lens device according to claim 1, wherein the first barrel member and the second barrel member move relatively in an optical axis direction of the lens device.

13. The lens device according to claim 1, wherein the first barrel member and the second barrel member move relatively in a rotation direction around an optical axis of the lens device.

14. An imaging apparatus comprising:
the lens device according to claim 1; and
an imaging element configured to capture an image of a subject through the lens device.
